(19) United States
(12) Patent Application Publication
(10) Pub. No.: US 2024/0282312 A1
(43) Pub. Date: Aug. 22, 2024

(54) VOICE PROCESSING DEVICE, METHOD, AND RECORDING MEDIUM

(71) Applicant: Panasonic Intellectual Property Management Co., Ltd., Osaka (JP)

(72) Inventors: Tomofumi YAMANASHI, Kanagawa (JP); Naoya MOCHIKI, Kanagawa (JP); Yutaka BANBA, Kanagawa (JP)

(21) Appl. No.: 18/415,339

(22) Filed: Jan. 17, 2024

(30) Foreign Application Priority Data
Feb. 22, 2023 (JP) 2023-026010

(51) Int. Cl. G10L 17/02; G06V 40/16

(52) U.S. Cl. CPC G10L 17/02; G06V 40/16

(57) ABSTRACT

A voice processing device includes a calculation unit and a determination processing unit. The calculation unit calculates a first feature being a feature of an input voice signal. When a similarity between the first feature and a second feature out of one or more registered features having been registered is equal to or larger than a first threshold, the determination processing unit makes determination that the input voice signal is a voice of a first registered person out of registered persons. The first registered person corresponds to the second feature. When the similarity is equal to or larger than the first threshold and smaller than a second threshold, the determination processing unit adds the first feature to the registered features or updates the registered features with the first feature.

### CROSS-REFERENCE TO RELATED APPLICATIONS

This application is based upon and claims the benefit of priority from Japanese Patent Application No. 2023-026010, filed on Feb. 22, 2023, the entire contents of which are incorporated herein by reference.

### FIELD

The present disclosure relates to a voice processing device, a method, and a recording medium.

### BACKGROUND

There is a conventional speaking person recognition technology to recognize a speaking person by comparing voice data of the speaking person with voice data having been registered.

A patent literature JP 2019-514045 A discloses a recognition technology to recognize a command from a user, from continuous words of speech from which words of speech made by a person other than the user is removed.

### SUMMARY

A voice processing device according to the present disclosure includes a memory in which a computer program is stored and a hardware processor coupled to the memory. The hardware processor is configured to perform processing by executing the computer program. The processing includes calculating a first feature being a feature of an input voice signal. The processing includes, when a similarity between the first feature and a second feature out of one or more registered features having been registered is equal to or larger than a first threshold, making determination that the input voice signal is a voice of a first registered person out of registered persons. The first registered person corresponds to the second feature. The processing includes, when the similarity is equal to or larger than the first threshold and smaller than a second threshold, adding the first feature to the registered features or updating the registered features with the first feature.

### BRIEF DESCRIPTION OF THE DRAWINGS

FIG. 1 is a diagram illustrating an example of a functional block configuration of a voice processing device according to a first embodiment;

FIG. 2 is a diagram illustrating an exemplary flowchart of the voice processing device according to the first embodiment;

FIG. 3 is a diagram illustrating an example of a UI screen of the voice processing device according to the first embodiment;

FIG. 4 is a diagram illustrating an example of a UI screen of a voice processing device according to a modification of the first embodiment;

FIG. 5 is a diagram illustrating an example of a functional block configuration of a voice processing device according to a second embodiment;

FIG. 6 is a diagram illustrating an exemplary flowchart of the voice processing device according to the second embodiment; and

FIG. 7 is a diagram illustrating an example of a hardware block configuration of a voice processing device.

### DETAILED DESCRIPTION

Hereinafter, embodiments of a voice processing device, a method, and a recording medium according to the present disclosure will be described in detail with reference to the accompanying drawings.

### First Embodiment

### Schematic Configuration of Voice Processing Device

A voice processing device 1 described below is applicable to a device that is activated, executes a command, or the like responding to a voice of a user. An example of the device to which the voice processing device 1 is applicable includes a home electric appliance, a mobile terminal, or an in-vehicle device.

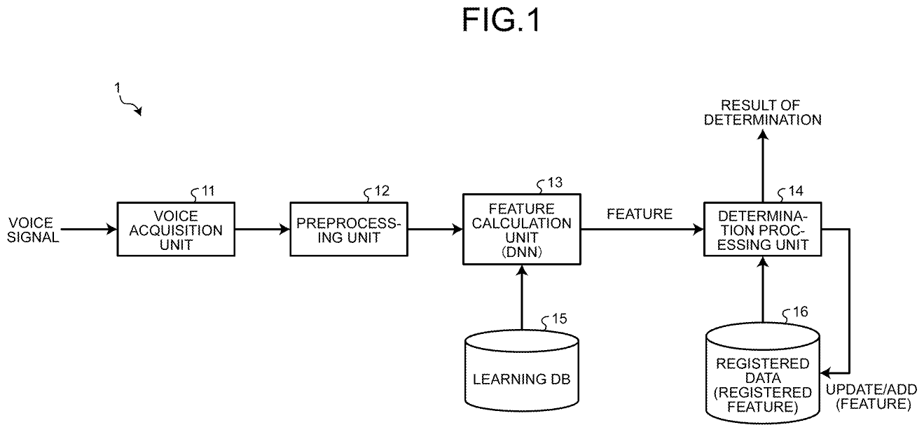

As illustrated in FIG. 1, the voice processing device according to a first embodiment includes a voice acquisition unit 11, a preprocessing unit 12, a feature calculation unit 13, and a determination processing unit 14.

In the present embodiment, a configuration is illustrated in which the voice acquisition unit 11 and the preprocessing unit 12 are provided as a “calculation unit” together with the feature calculation unit 13.

The “calculation unit” only needs to include at least the feature calculation unit 13, and an input voice signal may be received from another unit.

The voice acquisition unit 11 acquires the voice signal and outputs the voice signal to the preprocessing unit 12. In one example, the voice acquisition unit 11 acquires the voice signal through a microphone. The voice signal acquired by the voice acquisition unit 11 contains an environmental sound, noise, and the like in addition to a human voice, and therefore, a signal including these may be referred to as an input signal below.

The preprocessing unit 12 preprocesses the voice signal output from the voice acquisition unit 11 and outputs the voice signal to the feature calculation unit 13. In one example, the preprocessing is calculation of a speech segment, passband limitation of a signal in the speech segment by application of a high-pass filter, or the like.

The feature calculation unit 13 calculates a first feature that is a feature of the input voice signal. In one example, the feature calculation unit 13 is a deep neural network (DNN). The DNN is a learned model trained by an enormous number of data included in a learning DB 15. When the voice signal is input to the DNN, calculation processing on the voice signal is performed from an input layer via intermediate layers, and the first feature as a result of the calculation is obtained from an output layer. The first feature includes one or more factors (i.e., parameters). The feature of the voice is indicated by a magnitude of a value of each factor, a ratio between the values of the factors, etc. In one example, the frequency of the voice, speaking rhythm, or the like can be generated as the type of each factor. From the output layer, a value of each factor related to voice recognition of the speaking person can be extracted as the first feature.

The determination processing unit 14 compares the first feature obtained from the feature calculation unit 13 with registered data registered in a registration unit 16, and determines the speaking person on the basis of a similarity between the first feature and the registered data. In addition, the determination processing unit 14 updates the registered data when the similarity satisfies a predetermined condition.

The registered data refers to a file or the like, in which a feature of the speaking person upon registration is registered. Hereinafter, the feature having been registered is referred to as a “registered feature” in some cases, for convenience. The number of registered features may be for one person or for the number of registered persons. When there are plural registered persons, the number of registered feature is plural as well. Registration of the registered features in association with the registered persons makes it possible to identify each registered person. Note that, in the following description, it is assumed that the number of registered persons is one for ease of understanding.

The similarity refers to a similarity between the first feature and the registered feature. The similarity is calculated by comparing sets of values of factors included in the first feature and the registered feature, by a predetermined method. The method of calculating the similarity is not particularly limited. Any appropriate method may be used.

The determination processing unit 14 determines whether a similarity X, which is a similarity between the first feature and the registered feature having been registered, is equal to or larger than a first threshold TH1. The determination processing unit 14 then makes determination that the input voice signal is a voice of a first registered person corresponding to a second feature out of the registered persons, when the similarity X to the second feature of one or more registered features having been registered is equal to or larger than the first threshold TH1. Moreover, when the similarity X is smaller than the first threshold TH1, the determination processing unit 14 makes determination that the input voice signal is not a voice of the registered person, namely, a voice of an unregistered person. These determination conditions are expressed by a condition I shown below.

$$Determination condition I$$

$$Similarity X \geq TH 1 ( registered person )$$

$$Similarity X < TH 1 ( unregistered person )$$

Moreover, when the similarity X is equal to or larger than the first threshold TH1, the determination processing unit 14 further determines whether the similarity X is smaller than a second threshold TH2. In response to determining that the similarity X is smaller than the second threshold TH2, the determination processing unit 14 updates the second feature with the first feature, that is, updates the registered feature. When the similarity X is equal to or larger than the second threshold TH2, the determination processing unit 14 does not update the registered feature with the first feature. These determination conditions are expressed by a condition II shown below.

$$Determination condition II$$

$$TH 1 \leq Similarity X < TH 2 ( updated )$$

$$TH 2 \leq Similarity X ( not updated )$$

It is assumed that, for example, the first threshold TH1 is set to 95% and the second threshold TH2 is set to 98%. In this case, when the similarity X between the first feature and the second feature is equal to or larger than 98%, the first feature is considered to be substantially the same as the second feature, and thus the second feature is not updated with the first feature. On the other hand, when the similarity X between the first feature and the second feature is equal to or larger than 95% and smaller than 98%, there is a relatively clear difference between the first feature and the second feature. In this case, the determination processing unit 14 updates the second feature with the first feature. Performing the update in this manner, the latest second feature of the first registered person having been updated is used as a new criterion for determination, in the subsequent determination of the voice of the speaking person who is the first registered person. Note that the set values of the first threshold TH1 and the second threshold TH2 are each one example, and are not limited thereto. In addition, the settings of the first threshold TH1 and the second threshold TH2 may be changed (may be variable in settings) so as to change the settings later in accordance with the environments and conditions. In one example, a setting changing unit such as an operation panel may be connected to the voice processing device 1, and the setting changing unit is used for changing the settings for values of the first threshold (TH1) and the second threshold (TH2) in the determination processing unit 14. Such a setting changing unit may be connected to the voice processing device 1 in a wired manner or wireless manner.

In the voice processing device 1, a result of the determination by the determination processing unit 14 according with the above-described determination condition I may be output to a control unit or the like. The control unit determines an operation to be performed by the voice processing device 1 on the basis of the result of the determination. In one example, in response to determining that the input voice is the voice of the registered person, the control unit executes a predetermined command received from the speaking person of the voice. In addition, in response to determining that the input voice is the voice of the unregistered person, the control unit stands by without accepting any command until the voice of the registered person is input.

The voice processing device 1 may transmit the result of the determination to an external device configured to communicate with the voice processing device 1. Such a configuration makes it possible to activate the external device or cause the external device to execute the predetermined command, with the voice of the registered person, in response to reception of the result of the determination from the voice processing device 1. Note that the type of the external device is not limited. Any appropriate external device may be used.

### Process in Voice Processing Device

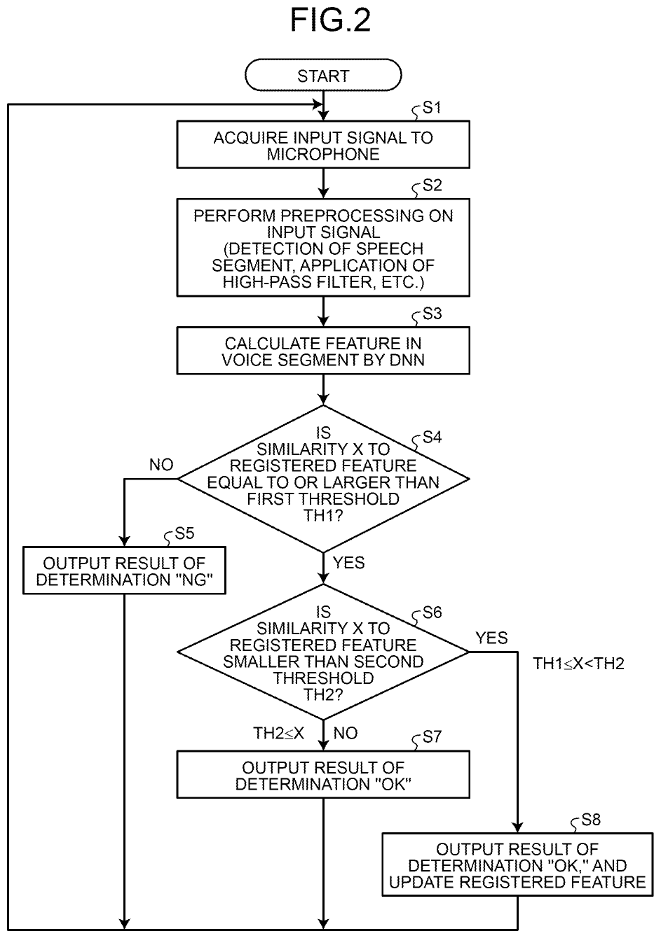

Next, a voice process in the voice processing device 1 will be described with reference to a flowchart of FIG. 2. Note that, in the following description, the voice processing device 1 is on standby so as to receive the voice signal input from the microphone.

As illustrated in FIG. 2, the voice acquisition unit 11 acquires the input signal via the microphone (Step S1). Subsequently, the preprocessing unit 12 performs preprocessing on the input signal (Step S2). For example, the preprocessing unit 12 detects the speech segment of the input signal and outputs a signal in the speech segment.

Subsequently, the feature calculation unit 13 calculates the feature of the preprocessed voice signal (Step S3). In one example of the present embodiment, the first feature of the voice signal is calculated by DNN. In a case where the signal of the speech segment has been output in Step S2, the feature in the speech segment is calculated in Step S3.

Subsequently, the determination processing unit 14 compares the first feature obtained from the feature calculation unit 13 with the registered feature of the registered data, and determines whether the similarity X between the first feature and the registered feature is equal to or larger than the first threshold TH1 (Step S4).

In response to determining that the similarity X is smaller than the first threshold TH1 (Step S4: No), the determination processing unit 14 makes determination that the input voice is a voice of the unregistered person, and outputs a result of the determination “NG” (Step S5). In one example, an output destination of the result of the determination is the control unit. Thereafter, the voice processing device 1 proceeds to Step S1. Processing from Step S1 is performed on a subsequent input voice signal.

In response to determining that the similarity X is equal to or larger than the first threshold TH1 (Step S4: Yes), the determination processing unit 14 makes determination that the input voice is a voice of the registered person, and further determines whether the similarity X is smaller than the second threshold TH2 (Step S6).

In response to determining that the similarity X is not smaller than the second threshold TH2 (Step S6: No), the determination processing unit 14 outputs a result of the determination “OK” (Step S7). Thereafter, the voice processing device 1 proceeds to Step S1.

Moreover, in response to determining that the similarity X is smaller than the second threshold TH2 (Step S6: Yes), the determination processing unit 14 outputs the result of the determination “OK”, and updates the registered feature of the registered person with the first feature (Step S8). Thereafter, the voice processing device 1 proceeds to Step S1.

### Difference Between Update Method and Addition Method

Note that the voice processing device 1 of the present embodiment uses, but is not limited to, an “update method” to update a registered feature having been registered with the first feature of the registered person newly calculated. In other words, the voice processing device 1 uses, but is not limited to, the “update method” to replace one of the registered features having been registered, with the first feature. An “addition method” may be used for registering the first feature of the registered person newly calculated while leaving registered features having been registered as they are.

The update method is useful for, for example, irreversible change of the first feature of the input voice signal. An example of the irreversible change includes a change in the voice quality of the registered person with time.

The voice processing device 1 updates the registered feature when the condition of first threshold TH1≤similarity X<second threshold TH2 is satisfied. In other words, the registered feature is not updated when the voice quality of the registered person slightly changes, but the registered feature of the registered person is updated when the voice quality changes by a given amount or more from the time of registration. When the voice quality of the registered person changes with time, the registered feature having been registered in the past is not required, thus updating the registered feature to suppress a memory capacity. Moreover, reduced number of registered features to be compared in the determination processing leads to a reduction in processing load of the voice processing device 1.

As an example of the irreversible change, a change in the voice quality of the registered person has been described, but the irreversible change is not limited to the change in the voice quality. For example, the update method is useful as well, when the first feature of the input voice signal changes year by year due to aging of the device or the like.

In the addition method, a variety of registered features of one speaking person are provided, and therefore, the registered person him-/her-self is highly likely to be recognized.

When the addition method is performed, it is desirable to limit the number of registered features in consideration of the memory capacity and the processing load on the voice processing device 1. For example, it is considered to set the upper limit to the number of registered features to be registered per person, such as up to three registered features per registered person.

Determination method of determining whether to select which one of update method and addition method

The voice processing device 1 of the present embodiment may selectively perform either the update method or the addition method, on the basis of a result of a determination as to whether a predetermined condition is satisfied. In one example, the voice processing device 1 may selectively perform the update or addition of the feature on the basis of the similarity between the first feature and the registered feature, until the number of registered features reaches the upper limit. In addition, when the number of registered features reaches the upper limit, the voice processing device 1 performs only the update instead of the addition.

When updating the registered feature, the voice processing device 1 updates a registered feature having the closest similarity so as to leave different types as much as possible.

### Determination Method Assuming Similar Voice Qualities of Registered Persons

In a case where the features of the registered persons having similar voice qualities are registered, there is a possibility that the registered feature of a registered person, other than the speaking person, who has a similar voice quality may have higher similarity to the first feature of the speaking person. In such a case, in the voice processing device 1, a user interface (UI) unit, as the setting changing unit, may change the first threshold TH1 and the second threshold TH2 to have higher values relative to initial values, upon initial registration of the feature.

In a case where the voice processing device 1 is provided with a display, the UI unit outputs a UI screen on the display, and accepts initial registration via the UI screen. The UI unit may receive selection of various buttons provided on the UI screen by operation of a hardware key by the user, or may receive selection of various buttons provided on the UI screen by touching of the UI screen.

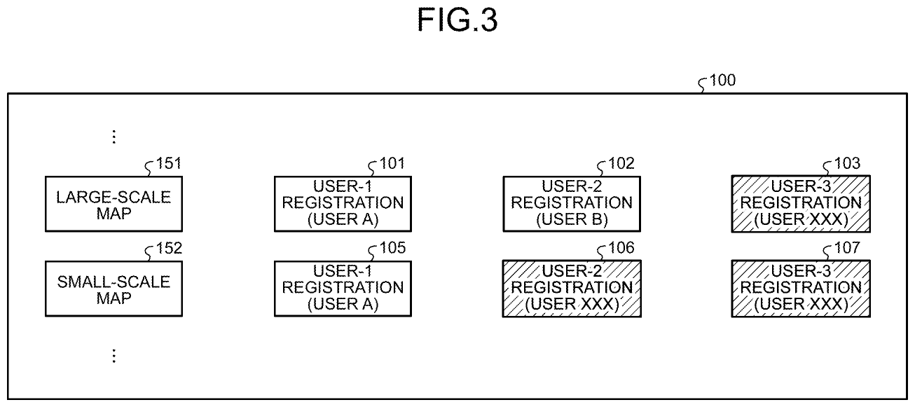

A UI screen 100 illustrated in FIG. 3 is an example of the UI screen of the in-vehicle device. The UI screen 100 is provided with navigation operation buttons and the like. A large-scale map button 151 and a small-scale map button 152 are examples of the navigation operation buttons. On the UI screen 100, various operation buttons “ . . . ” other than the large-scale map button 151 and the small-scale map button 152 may be arranged.

Moreover, the UI screen 100 is provided with a plurality of user registration buttons. In one example, the UI screen 100 of FIG. 3 is provided with a user-1 registration button 101, a user-2 registration button 102, and a user-3 registration button 103, which are registration buttons provided for three users.

In addition, the UI screen 100 desirably display whether the feature has been registered or has not been registered in a visually recognizable manner. For example, in the UI unit, user registration buttons indicating that the feature has been registered is displayed in white and user registration buttons indicating that the feature has not been registered is displayed in gray or the like, on the UI screen 100, in a visually recognizable manner.

In addition, it is desirable to provide a display so that a user him-/her-self who has registered the feature and other users can recognize whether the user who has registered the feature uses which of “user 1”, “user 2”, and “user 3”. In one example, the user-1 registration button 101, the user-2 registration button 102, and the user-3 registration button 103 are configured to be individually changed in text, display color, or the like so that each registration button used for registration by each user can be recognized. In addition to the change in text or display color, another method for recognition by the user him-/her-self who has registered the feature or other users may be appropriately adopted.

Moreover, the UI screen 100 is provided with further registration buttons for the three users so that each of the three users can register the feature for each command. On the upper side of the UI screen 100, the user-1 registration button 101, the user-2 registration button 102, and the user-3 registration button 103, which are registration buttons for the three users, are positioned as the registration buttons corresponding to a command 1. On the lower side of the UI screen 100, a user-1 registration button 105, a user-2 registration button 106, and a user-3 registration button 107, which are registration buttons for the three users, are arranged as the registration buttons corresponding to a command 2. Note that the number of users that can be registered, the number of commands that can be registered, the number of registration buttons, the arrangement of the registration buttons, and the like are merely examples, and the present disclosure is not limited thereto.

When the user actively operates his/her own registration button on the UI screen 100, the following registration processing is performed.

As an example of the registration processing, registration processing will be described where a user B registers a feature of the command 2 in a state where only a user A finishes the registration of a feature of the command 2.

In FIG. 3, the user-1 registration button 105 indicating completion of registration is displayed because the user A has registered the feature of the command 2. In one example, a color indicating completion of registration is displayed in white. In the user-2 registration button 106 and the user-3 registration button 107, the feature of the command 2 has not been registered, and therefore, the buttons indicating non-registration are displayed. As an example, a color of display indicating non-registration is represented by hatching.

In this state, the user B selects the user-2 registration button 106 indicating a non-registration state, and performs initial registration of the feature of the command 2. First, the user B presses the user-2 registration button 106 and speaks the command 2. In the voice processing device 1, the first feature is calculated by the feature calculation unit 13, and the first feature as a result of the calculation is registered by the determination processing unit 14, as described above. In the present example, the determination processing unit 14 determines reception of the selection of the user-2 registration button 106 on the UI screen 100 by the UI unit, as an instruction for registration of the feature of the command 2 by the user 2, and further performs the following processing.

The determination processing unit 14 compares the first feature of the user B with the registered feature of another user whose feature of the command 2 has been registered, on the basis of the instruction for registration of the feature of the command 2 by the user 2. In one example, the feature of the command 2 has been registered only for the user 1 used by the user A, and therefore, the determination processing unit 14 compares the first feature of the user B with the registered feature of the command 2 corresponding to the user 1. When comparison between the first feature of the user B and the registered feature of the command 2 corresponding to the user 1 indicates that the similarity X is equal to or larger than a predetermined value, the determination processing unit 14 makes a change to raise the first threshold TH1 and second threshold TH2 for the user 2 selected by the user B and the first threshold TH1 and second threshold TH2 for the user 1. The first threshold TH1 and the second threshold TH2 are thresholds used for determination of update or addition of the registered feature.

After the registration, the display of the user-2 registration button 106 is changed to display completion of registration. Moreover, the voice processing device 1 may be configured to notify the user of the completion of registration by a method other than display, after the registration of the feature is completed.

Note that, here, an example has been described in which only the user A as the user 1 is the user whose feature of the command 2 has been registered, but the features of the command 2 of multiple users may be registered. In a case where multiple users including a user C or the like have registered the features of the command 2, the determination processing unit 14 compares the first feature of the user B with the registered feature of each user whose feature of the command 2 has been registered, and determines whether the similarity X is equal to or larger than the predetermined value for each registered feature. The determination processing unit 14 makes a change to raise the first threshold TH1 and second threshold TH2 for the user 2 used by the user B and the first threshold TH1 and second threshold TH2 for a user, when the similarity X between the users is equal to or larger than the predetermined value. Note that raising the second threshold TH2 has been described here, but it is not always necessary to change the second threshold TH2. It may not be necessary to change the second threshold TH2 in some cases, and the determination processing unit 14 preferably changes at least the first threshold TH1.

The registration processing for the command 2 has been exemplified, but commands other than the command 2 can be processed in the similar manner.

Moreover, the determination processing unit 14 may calculate a similarity to the registered features of other users having been registered, every time a new user registers a feature to a given command.

In this way, the registration button for each user is provided, and the user actively registers the feature of his/her own voice. When a feature of a user is newly registered, the voice processing device 1 calculates a similarity between the feature of the new user and the registered feature of another user, and checks whether the feature of the new user is similar to the registered feature of the other user. When the registered features of the other user have a registered feature similar to the feature of the new user, the voice processing device 1 makes a change to raise the first threshold TH1 of the user who has newly registered the feature. In addition, the voice processing device 1 makes a change to raise the first threshold TH1 of the user whose registered feature is similar to the feature of the new user. In other words, when there is a registered feature similar to the new feature, the change for raising the first threshold TH1 is performed for two users or two or more users who have similar voice qualities. In this way, in a case where the voice qualities of the registered persons are similar to each other, the change for raising at least the first threshold TH1 between the registered users can be performed to make it difficult to update or add the registered feature of another registered person whose voice quality is similar to that of the registered person him-/her-self.

In addition, the determination processing unit 14 may perform the update or addition after multiple times of determination of first threshold TH1≤similarity X<second threshold TH2. For example, the feature calculation unit 13 calculates the feature for each speech segment, and the determination processing unit 14 sequentially determines the similarity between the feature calculated for each speech segment and the registered feature. The determination processing unit 14 may update or add the registered feature in response to determining that first threshold TH1≤ similarity X<second threshold TH2 is satisfied in predetermined plural segments.

In this way, updating or adding the registered feature after the result of the determination of the feature for each of the predetermined segments is obtained makes it possible to prevent changing or adding the registered feature of the registered person him-/her-self, with the feature of another person, other than the person him-/her-self, whose voice quality is similar to that of the person him-/her-self.

In the description of the present embodiment, the voice processing device 1 includes the voice acquisition unit 11 and the preprocessing unit 12, but the voice processing device 1 is not limited to this configuration. The voice processing device 1 preferably includes at least the feature calculation unit 13 and the determination processing unit 14 that process the input voice signal. For example, the voice processing device 1 having a configuration to receive the voice signal from an external device makes it possible to process the input voice signal by the feature calculation unit 13 and the determination processing unit 14.

### Effects of First Embodiment

Even a voice input from the same person may slightly change over time. When the feature of the voice input by the registered person changes from the registered feature, a lower similarity to the registered feature is calculated. In such a case, even a registered person may be erroneously determined not to be the registered person. The voice processing device 1 of the present embodiment updates or adds the registered feature when the relationship of first threshold TH1≤ similarity X<second threshold TH2 is satisfied. In other words, even when the similarity between the first feature being a feature calculated from the input voice signal and the registered feature is not high, the voice processing device 1 of the present embodiment makes determination that a voice having the similarity at a given level or more is the voice of the same person. Then, when the similarity is smaller than the predetermined value, the voice processing device 1 adds the first feature as the registered feature or updates the registered feature with the first feature. Therefore, the voice processing device of the present embodiment can reduce erroneous determination.

### First Modification of First Embodiment

As a first modification of the first embodiment, a configuration for reducing erroneous determination caused by a Lombard effect will be described. The Lombard effect refers to a phenomenon that the way of speaking of a speaking person temporarily changes so that others can easily hear in a noisy environment such as in loud noise. Due to the occurrence of the Lombard effect, the voice quality of the speaking person is different from the usual one. The configuration to reduce the erroneous determination caused by the Lombard effect will be described below.

The voice processing device 1 determines whether the Lombard effect has occurred, by detecting ambient noise in a segment having no speech by the speaking person in the input voice signal. In one example, the preprocessing unit 12 detects a noise signal with a sensor or the like in a section of the voice signal having no speech, and makes determination that the Lombard effect has occurred when the noise signal indicates a volume at a given level or more. The sensor is, for example, a microphone. In response to determining that the Lombard effect has occurred, the voice processing device 1 adds a feature calculated from the input voice signal of the speaking person, as a registered feature of the speaking person. This configuration makes it possible for the voice processing device 1 to reduce erroneous determination of the voice of the registered person, even when the voice quality of the registered person changes upon occurrence of the Lombard effect.

Note that the voice processing device 1 may add the feature calculated upon occurrence of the Lombard effect as a “registered feature upon the Lombard effect” of the speaking person. As described above, the registration of the registered feature corresponding to the occurrence of the Lombard effect, in addition to the registered feature in normal times, makes it possible for the voice processing device 1 to calculate the similarity only on the basis of the “registered feature upon the Lombard effect” when the Lombard effect occurs. Therefore, the processing load in the determination processing can be reduced.

Moreover, in a case where the voice processing device 1 is applied to the in-vehicle device, the Lombard effect may occur due to road noise during traveling of the vehicle. In preparation for the occurrence of the Lombard effect, the feature upon occurrence of the Lombard effect may be registered at the initial registration of the feature, in addition to the feature in a quiet state. For example, the feature upon occurrence of the Lombard effect may be acquired in a pseudo traveling environment formed by reproducing a sound of pseudo road noise from a speaker. The speaker is, for example, a car speaker. The voice processing device 1 may include the speaker.

For example, while the sound of pseudo road noise is reproduced from the speaker, a signal component of the sound of pseudo road noise reproduced by the speaker is echo-canceled from the voice signal input to the voice processing device 1. In one example, an echo cancellation unit (an example of a cancellation mechanism) is provided in the microphone to perform echo cancellation on the input voice signal.

In this way, echo cancellation from the input signal for the signal component of the sound of the pseudo road noise reproduced by the speaker makes it possible to extract clear voice of the speaking person. The voice processing device 1 may register a feature calculated based on this voice as the registered feature upon occurrence of the Lombard effect.

### Second Modification of First Embodiment

The voice processing device 1 may register multiple types of features. While the examples of registration of the feature in the quiet state and the feature upon occurrence of the Lombard effect has been described above, other features may be registered.

For example, the feature changes between a voice of the registered person wearing a face mask, that is, the voice output through the face mask, and a voice of the registered person wearing no face mask, that is, the voice output without the face mask. Considering such a change, the voice processing device 1 may register the feature upon wearing the face mask and the feature upon wearing no face mask. Then, when the speaking person is wearing the face mask, the voice processing device 1 makes determination on the basis of a similarity between the first feature calculated from a voice signal upon wearing the face mask and the registered feature upon wearing the face mask. Additionally, when the speaking person is wearing no face mask, the voice processing device 1 makes determination on the basis of a similarity between the first feature calculated from a voice signal upon wearing no face mask and the registered feature upon wearing no face mask. Determination as to whether the speaking person is wearing the face mask can be made on the basis of an image captured by a camera, for example.

In this way, the feature upon wearing the face mask may be appropriately registered as well. In addition, if there is any other change in the feature, registration may be appropriately performed. For example, the voice quality can change as well, depending on a change in physical condition of the speaking person, such as a slight cold. A feature corresponding to the change in physical condition may be registered in the voice processing device 1.

The feature may be registered automatically or manually. For example, the feature may be registered in the voice processing device 1 automatically on the basis of a voice spoken and input. Alternatively, the user may register the feature by him-/her-self by manually operating the voice processing device 1. Moreover, the voice processing device 1 may be configured to be selectively used automatically or manually.

Next, the UI screen of the UI unit provided to select the type of a mode for registering the feature will be described.

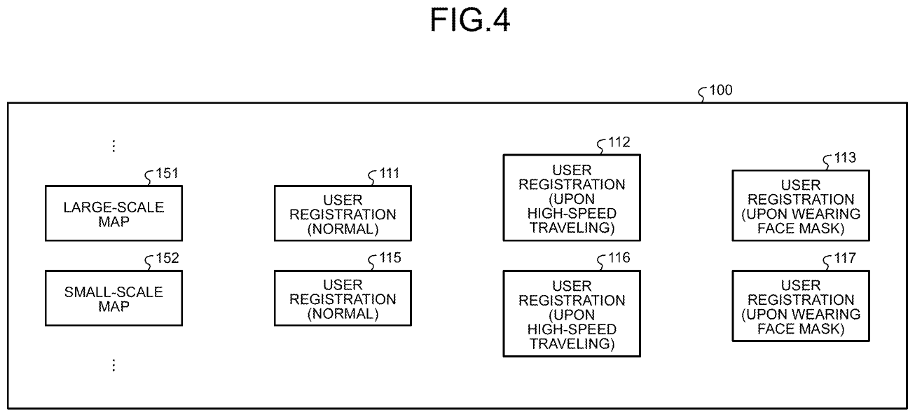

The UI screen 100 illustrated in FIG. 4 is another example of the UI screen 100 of the in-vehicle device illustrated in FIG. 3.

On the UI screen 100, a user registration button for registration of a feature is provided for each registration mode. In FIG. 4, the UI screen 100 is provided with a user registration button 111 that registers a normal feature as a first registration mode, a user registration button 112 that registers a feature upon high-speed traveling as a second registration mode, and a user registration button 113 that registers a feature upon wearing the face mask as a third registration mode. The normal feature is, for example, a feature registered in the quiet state. In this way, providing the registration button for each mode makes it possible for the user to actively select an appropriate registration mode. The voice processing device 1 can set an environment that enables registration in the selected registration mode.

Moreover, in the UI screen 100, registration buttons are provided for each of two users to perform registration. On the upper side of the UI screen 100, the user registration button 111, the user registration button 112, and the user registration button 113 are positioned as registration buttons for the user 1. On the lower side of the UI screen 100, a user registration button 115, a user registration button 116, and a user registration button 117 are positioned as registration buttons for the user 2.

Note that the number of users that can be registered, the types of registration modes, the number of registration buttons, and the arrangement of the registration buttons are merely examples, and the present disclosure is not limited thereto.

The initial registration for each mode is performed, for example, as follows. First, the user manually presses a registration button as a registration target. The voice processing device 1 sets the registration mode to a registration mode corresponding to the registration button pressed by the user. When the user registration button 111 is pressed, the voice processing device 1 calculates the first feature on the basis of a voice input through speaking of the user, and registers the first feature as the normal registered feature. Moreover, when the user registration button 112 is pressed, the voice processing device 1 reproduces, for example, the pseudo road noise from the speaker, calculates the first feature on the basis of a voice input through speaking of the user while reproducing the load noise, and registers the first feature as the registered feature upon high-speed traveling. Moreover, when the user registration button 113 is pressed, the voice processing device 1 calculates the first feature, on the basis of a voice input through speaking while the user is wearing the face mask, and registers the first feature as the registered feature upon wearing the face mask.

Note that the voice processing device 1 may be configured to notify the user of the completion of registration after the initial registration of the registered feature is completed. The voice processing device 1 may notify the user of the completion of registration in association with the registration mode after the registration of the registered feature is completed. For example, the voice processing device 1 may notify of a message “High-speed traveling mode has been registered” by using voice output or screen display, after the registration of the registered features upon high-speed traveling is completed.

In addition, the voice processing device 1 may cause the UI screen 100 to display a mode for which the feature has not been registered in a visually recognizable manner. For example, the voice processing device 1 may display, on the UI screen 100, a user registration button corresponding to a mode for which the feature has been registered, in white, and a user registration button corresponding to a mode for which the feature has not been registered, in a color different from white, for example, gray.

In addition, after the voice processing device 1 stores the registered features corresponding to multiple modes, the determination processing unit 14 may automatically determine a mode. Then, when the similarity between the first feature calculated from the input voice signal and the second feature out of one or more registered features corresponding to the determined mode is equal to or larger than the first threshold, the determination processing unit 14 may make determination that the voice signal is the voice of the first registered person corresponding to the second feature. For example, the voice processing device 1 can automatically determine an appropriate mode by using a detection unit such as a sensor.

### Second Embodiment

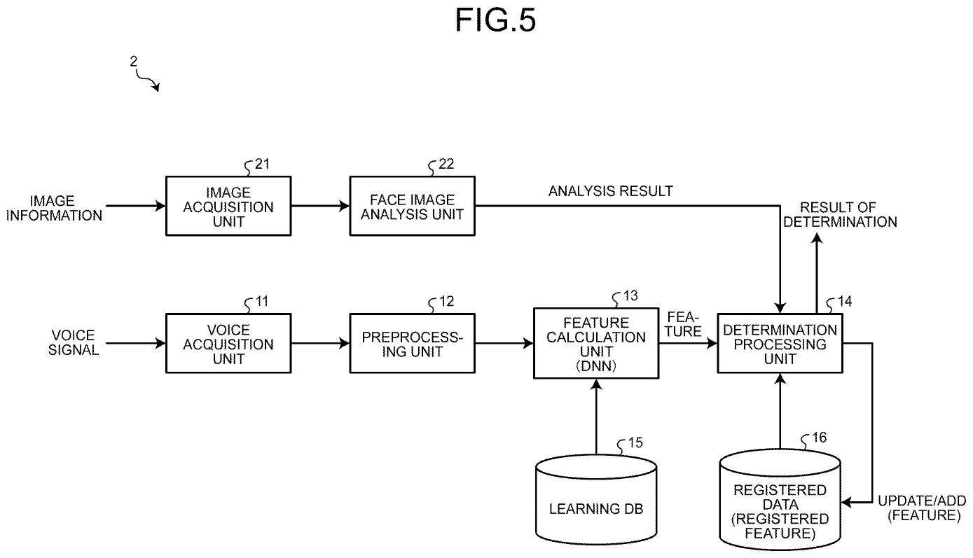

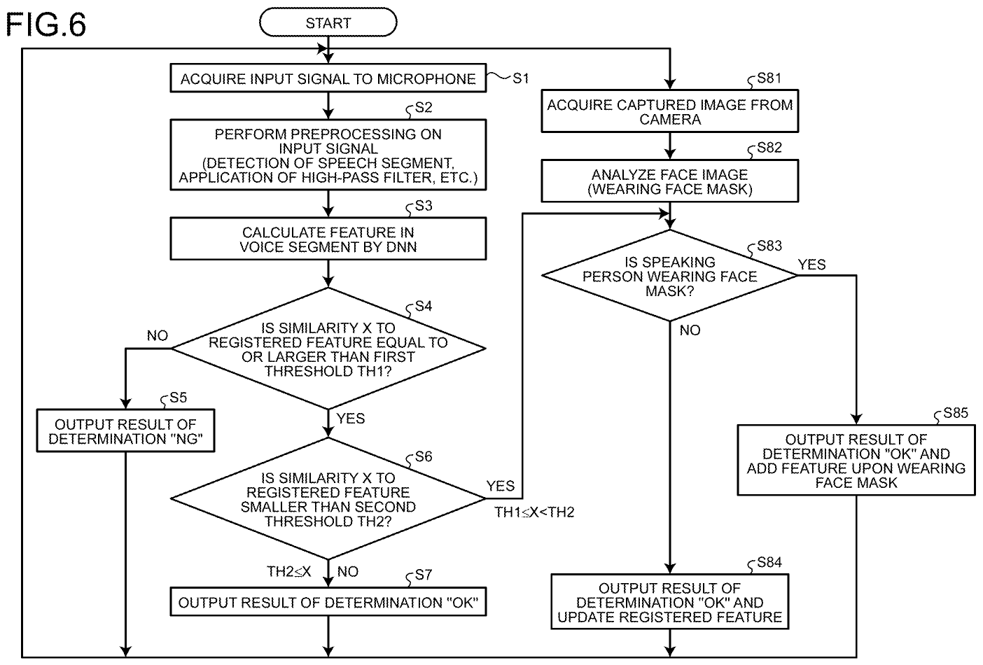

A second embodiment will be described in detail with reference to FIGS. 5 and 6. Note that, in FIGS. 5 and 6, parts common to those in the first embodiment are denoted by, for example, the same reference numerals, repetitive description will be omitted as appropriate, and parts different from those in the first embodiment will be mainly described.

As illustrated in FIG. 5, a voice processing device 2 of the second embodiment further includes an image acquisition unit 21 that acquires a captured image from a camera, and a face image analysis unit 22 that analyzes a face image from the captured image. The image acquisition unit 21 and the face image analysis unit 22 correspond to a “detection unit” and a “recognition unit”.

The determination processing unit 14 performs processing such as the initial registration, update, or addition of the registered feature, on the basis of an analysis result output from the face image analysis unit 22.

The face image analysis unit 22 analyzes the face image in the captured image. In one example, the face image analysis unit 22 analyzes whether the speaking person is wearing the face mask. In addition, if the face image of the registered person acquired from the camera is stored in a face image database to which the face image analysis unit 22 is accessible, the face image analysis unit 22 can also perform facial recognition of the registered person by using the face image of the registered person and the captured image. The face image analysis unit 22 may perform update or addition of the face image of the registered person to the face image database, upon updating and adding the registered feature. Processing of the voice processing device 2 in a case where the face image analysis unit 22 adds a result of the facial recognition of the registered person to the analysis result will be described, as one example.

FIG. 6 is a flowchart corresponding to a process performed when the feature upon wearing the face mask has not been registered, illustrating a process in which the voice processing device 2 automatically registers the feature upon wearing the face mask.

The image acquisition unit 21 acquires the captured image from the camera (Step S81). The face image analysis unit 22 analyzes the face image from the captured image (Step S82). The face image analysis unit 22 analyzes the face image to determine whether the speaking person is wearing the face mask. In addition, the face image analysis unit 22 may perform facial recognition to recognize whether the speaking person is the registered person at this stage or before the voice is input. The face image analysis unit 22 outputs a result of the analysis to the determination processing unit 14. In Step S83, which is described later, processing performed when the face image analysis unit 22 outputs information indicating wearing the face mask and information about the registered person obtained by the facial recognition of the speaking person will be described.

In response to determining that the similarity X is smaller than the second threshold TH2 (Step S6: Yes), the determination processing unit 14 determines whether the speaking person is wearing the face mask (Step S83).

Since the information about the registered person corresponding to the speaking person is obtained from the result of the analysis in Step S82, the determination processing unit 14 determines “OK” as a result of the determination Accordingly, in response to determining that the speaking person is not wearing the face mask (Step S83: No), the determination processing unit 14 outputs a result of the determination “OK”. In addition, since the speaking person is not wearing the face mask, the determination processing unit 14 updates the registered feature of the registered person with the first feature (Step S84). Thereafter, the voice processing device 1 proceeds to Step S1.

Moreover, in response to determining that the speaking person is wearing the face mask (Step S83: Yes), the determination processing unit 14 outputs a result of the determination “OK”. In addition, since the speaking person is wearing the face mask, the determination processing unit 14 adds the first feature as the registered feature of the registered person wearing the face mask (Step S85). Thereafter, the voice processing device 1 proceeds to Step S1.

Note that, while an example of determining whether the speaking person is wearing the face mask by the determination processing unit 14 in Step S83 has been described, the face image analysis unit 22 may determine whether the physical condition of the speaking person has changed, in Step S82. Then, on the basis of a result of the determination, the determination processing unit 14 may determine whether the physical condition of the speaking person has changed, in Step S83. In addition, the determination processing unit 14 may perform either updating of the registered feature or addition of the registered feature upon a change in physical condition, depending on whether the physical condition of the speaking person has changed. The face image analysis unit 22 may perform person recognition in Step S82, and on the basis of a result of the recognition, the determination processing unit 14 may determine only whether the speaking person is the same person as the registered person in Step S83. The determination of wearing the face mask may be combined therewith. Moreover, in a case where the speaking person is determined in Step S83 not to be the same person as the registered person even when the similarity X of the first feature to the registered feature of the registered person is high, the determination processing unit 14 may be configured not to add or update the registered feature of the registered person. Furthermore, for example, in response to determining in Step S83 that the speaking person is the same person as the registered person, the first threshold TH1 and the second threshold TH2 may be lowered relative to the initial values. This configuration makes it possible to reduce the possibility that the voice processing device 1 erroneously makes determination that the speaking person is not the registered person even though the speaking person is the same person as the registered person.

Combining with the camera image in this way makes it also possible to determine whether the face mask is worn, determine whether the speaking person is the same person as the registered person, and the like. Moreover, even when the similarity X of the first feature of the input voice to the registered feature of the registered person is high, addition or update of the first feature is configured to be prevented unless it is determined, from the camera image, that the speaking person is the same person as the registered person. This configuration makes it possible to reduce the possibility that the voice processing device 1 erroneously determines the speaking person as the registered person although the person is not the same person as the registered person.

In addition, the detection by the camera is an example, and the detection unit is not limited to the combination with the camera. For example, in a mode such as the high-speed traveling mode, background noise may be detected by using any sensor.

### (Hardware Configuration of Voice Processing Device)

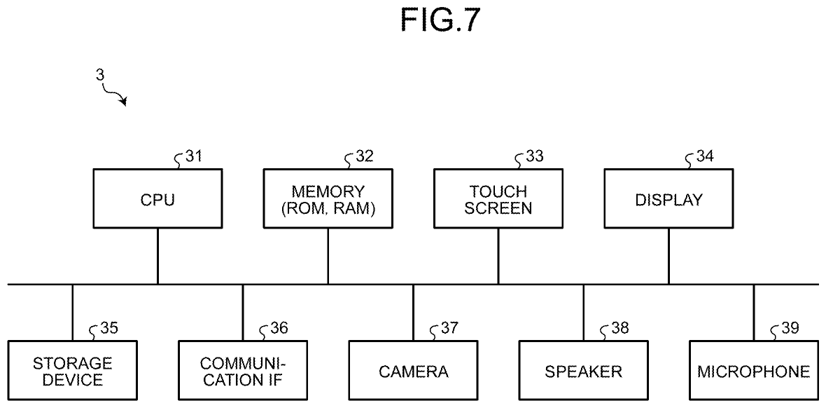

FIG. 7 is a diagram illustrating an example of a hardware block configuration of a voice processing device. The voice processing device 3 illustrated in FIG. 7 has a computer configuration including a central processing unit (CPU), and the CPU executes a computer program stored in a memory to provide various functions for the voice processing described above.

In one example, the voice processing device 3 includes CPU 31, a memory 32, a touch screen 33, a display 34, a storage device 35, a communication interface (IF) 36, a camera 37, a speaker 38, and a microphone 39, which are connected via a bus.

The CPU executes computer programs stored in the memory 32 to implement some or all of functional units such as the voice acquisition unit 11, the preprocessing unit 12, the feature calculation unit 13, and the determination processing unit 14. The CPU as the voice acquisition unit 11, the preprocessing unit 12, the feature calculation unit 13, and the determination processing unit 14 controls each unit of hardware or the like to perform voice processing.

The memory 32 includes a read only memory (ROM), a random access memory (RAM), and the like.

The touch screen 33 is stacked on a screen of the display 34 to detect a touch position on the screen.

The display 34 is a display such as a liquid crystal display. The UI screen 100 and the like are displayed on the display 34. The touch screen 33 and the display 34 are examples of the operation panel.

The storage device 35 is a hard disk drive (HDD) or a solid state drive (SSD). The registered data of the registered feature, the registered data of the face image, and the like are stored in the storage device 35. Note that the registered data of the registered feature and the registered data of the face image may be stored in an external system such that the registered data may be acquired from the outside via the communication IF 36 upon determination.

The communication IF 36 is a wired or wireless communication IF.

The camera 37 includes an imaging device such as a charge coupled device (CCD) or a complementary metal oxide semiconductor (CMOS) to output a captured image.

The speaker 38 outputs sound such as the pseudo road noise reproduced by the CPU 31.

The microphone 39 receives a voice and the like. The microphone 39 may include an echo cancellation unit.

Note that the hardware block configuration of the voice processing device is an example, and the present disclosure is not limited thereto. The configuration may be appropriately modified according with the type of the registration mode or the like.

The present disclosure can be implemented by software, hardware, or the software in cooperation with the hardware.

Note that the present disclosure may be implemented by a system, a device, a method, an integrated circuit, a computer program, or a recording medium, or may be implemented by any combination of the system, the device, the method, the integrated circuit, the computer program, and the recording medium. Moreover, the program product is a computer-readable medium on which a computer program is recorded.

In addition, a program in which some procedures or all procedures are recorded may be provided by being recorded in the recording medium or may be stored in the ROM so as to be provided as an information processing device configured as a computer, or the program may be downloaded via a network to be executed by a computer. CPU of the computer reads and executes the program and the processing is performed.

While the embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A voice processing device comprising:
a memory in which a computer program is stored; and
a hardware processor coupled to the memory and configured to perform processing by executing the computer program, the processing including:
calculating a first feature being a feature of an input voice signal;
when a similarity between the first feature and a second feature out of one or more registered features having been registered is equal to or larger than a first threshold, making determination that the input voice signal is a voice of a first registered person out of registered persons, the first registered person corresponding to the second feature; and,
when the similarity is equal to or larger than the first threshold and smaller than a second threshold, adding the first feature to the registered features or updating the registered features with the first feature.

2. The voice processing device according to claim 1, wherein, in the processing, the hardware processor performs the updating of the registered features with the first feature in response to determining that the similarity is equal to or larger than the first threshold and smaller than the second threshold due to a change in voice quality of the first registered person.

3. The voice processing device according to claim 1, wherein the first threshold and the second threshold are each variable in setting.

4. The voice processing device according to claim 1, wherein, in the processing, the hardware processor
calculates a feature for each predetermined segment of the voice signal, and
performs the adding of the first feature to the registered features or the updating of the registered features with the first feature in response to determining, as to the predetermined segments, that the similarity between the feature calculated for each predetermined segment and the registered feature is equal to or larger than the first threshold and smaller than the second threshold.

5. The voice processing device according to claim 1, further comprising:
a speaker configured to reproduce a sound; and
a cancellation mechanism configured to cancel, from the input voice signal, a signal of the sound reproduced by the speaker.

6. The voice processing device according to claim 1, further comprising a user interface used for selecting a type of a mode,
wherein, in the processing, the hardware processor registers the first feature in association with a mode selected by the user interface.

7. The voice processing device according to claim 1, further comprising a storage device in which registered features corresponding to multiple modes are stored,
wherein, in the processing, the hardware processor
automatically determines a mode among the multiple modes, and
makes the determination that the input voice signal is a voice of the first registered person corresponding to the second feature when a similarity between the first feature and the second feature is equal to or larger than the first threshold, the second feature being a feature out of one or more registered features corresponding to the determined mode.

8. The voice processing device according to claim 7, wherein
the processing further includes performing facial recognition of a speaking person, and,
in the processing, the hardware processor registers the first feature in association with the determined mode when the speaking person is recognized as the registered person as a result of the facial recognition and no feature corresponding to the determined mode has been registered in the storage device.

9. A method implemented by a computer, the method comprising:
calculating a first feature being a feature of an input voice signal;
when a similarity between the first feature and a second feature out of one or more registered features having been registered is equal to or larger than a first threshold, making determination that the input voice signal is a voice of a first registered person out of registered persons, the first registered person corresponding to the second feature; and,
when the similarity is equal to or larger than the first threshold and smaller than a second threshold, adding the first feature to the registered features or updating the registered features with the first feature.

10. A non-transitory computer-readable recording medium on which programmed instructions are recorded, the instructions causing a computer to execute processing, the processing comprising:
calculating a first feature being a feature of an input voice signal;
when a similarity between the first feature and a second feature out of one or more registered features having been registered is equal to or larger than a first threshold, making determination that the input voice signal is a voice of a first registered person out of registered persons, the first registered person corresponding to the second feature; and,
when the similarity is equal to or larger than the first threshold and smaller than a second threshold, adding the first feature to the registered features or updating the registered features with the first feature.
